(19) United States
(12) Patent Application Publication
(10) Pub. No.: US 2009/0320525 A1
(43) Pub. Date: Dec. 31, 2009

(54) Method of bubbling a gas into a glass melt

(76) Inventor: William Weston Johnson, Painted Post, NY (US)

Correspondence Address: CORNING INCORPORATED, SP-TI-3-1, CORNING, NY, 14831, US

(21) Appl. No.: 12/215,284

(22) Filed: Jun. 26, 2008

(51) Int. Cl. C03B 5/16

(52) U.S. Cl. 65/134.5; 65/346

(57) ABSTRACT

Feed materials are melted in a furnace to form a glass melt in a first vessel, transferred through a first refractory metal connecting tube to a second vessel for conditioning, then transferred through a second refractory metal connecting tube to a third vessel where the glass melt is fined. A gas is bubbled into the glass melt through an injection tube disposed in the first connecting tube, optionally in the second connecting tube, and optionally in both connecting tubes. The gas may be used to mix the melt and/or recharge a fining agent with oxygen.

### BACKGROUND OF THE INVENTION

1. Field of the Invention

This invention is directed to a method of forming a molten glass, and in particular for introducing a gas into a glass melt for the purpose of mixing and fining the molten glass. The invention is particularly useful for fining high melting temperature or high strain point glasses, such as those that are used for glass substrates for flat panel display devices.

2. Technical Background

Liquid crystal displays (LCDs) are flat panel display devices that include flat glass substrates or sheets. The fusion process is a preferred technique used to produce sheets of glass used in LCDs because the fusion process produces sheets whose surfaces have superior flatness and smoothness without the need for subsequent polishing compared to sheet produced by other methods. The fusion process is described, for example, in U.S. Pat. Nos. 3,338,696 and 3,682,609, the contents of which are incorporated herein by reference.

Conventional glass manufacturing processes for LCD glass typically begin by melting glass precursors—feed materials—in a melting furnace to produce a molten glass or glass melt. Reactions that occur during this melting stage release gases which form bubbles (also referred to as seeds or blisters) in the glass melt. Seeds may also be generated through the release of interstitial air trapped between particles of the feed materials. In any event, these gas bubbles must be removed in order to produce high quality glass. The removal of gaseous inclusions is generally accomplished by “fining” the glass.

Another recurring issue in the glass melting and forming process is producing glass that is well mixed. Inhomogeneities in the molten glass, such as chemical and density inhomogeneities, can result in streaks and cord in the glass, that may be visually unappealing and for some applications unacceptable.

A common method of fining a glass melt is by chemical fining. In chemical fining, a fining agent is introduced into the glass melt, such as by including the fining agent in the feed material. The fining agent is a multivalent oxide that is reduced (loses oxygen) at high temperatures, and is oxidized (recombines with oxygen) at low temperatures. Oxygen released by the fining agent may then diffuse into the seeds formed during the melting process causing seed growth. The buoyancy of the seeds is thereby increased, and they rise to the surface of the glass where the gas is released out of the melt. Ideally, it is desirable that the fining agent release oxygen late in the melting process, after most of the seeds have formed, to increase the effectiveness of the fining agent. To that end, although large seeds may be eliminated in the melter, the glass typically undergoes additional fining in a fining vessel, where the temperature of the glass is typically increased above the melting temperature. The increased melt temperature at the fining vessel reduces the viscosity of the glass melt, making it easier for seeds in the melt to rise to the surface of the melt. Additionally, the oxide fining agent will release oxygen to the melt to cause seed growth and assist with the seed removal process. Once the melt has been fined, it may be cooled and stirred to homogenize the melt, and thereafter formed, such as into a glass sheet, through any one of a variety of available forming methods known in the art.

Many glass manufacturing processes employ arsenic as a fining agent. Arsenic is among the highest temperature fining agents known, and, when added to the molten glass bath in the melter, it allows for O₂ release from the glass melt at high temperatures (e.g., above about 1450° C.). This high temperature O₂ release aids in the removal of seeds during melting and in particular during the fining stages of glass production, and coupled with a strong tendency for O₂ absorption at lower conditioning temperatures (which aids in the collapse of any residual gaseous inclusions in the glass), results in a glass product essentially free of gaseous inclusions.

From an environmental point of view, it would be desirable to provide alternative methods of making glass, and particularly high melting point and strain point glasses typically employed in the manufacture of LCD glass, without having to employ arsenic as a fining agent. Arsenic-containing compounds are generally toxic, and processing of glass with arsenic results not only in manufacturing wastes that are expensive to process, but also creates disposal issues relative to the display device itself after the useful life of the device is exhausted. Unfortunately, many alternative fining agents typically release less oxygen, and/or at too low a temperature, and reabsorb too little O₂ during the conditioning process relative to established fining agents such as arsenic, thereby limiting their fining and oxygen re-absorption capabilities. Thus, during the fining stage of the glass production process (i.e. while the glass is within the fining vessel), the fining agent may produce an insufficient quantity of oxygen to effectively fine the glass within the fining vessel.

It is also desirable to increase the effectiveness of the mechanical mixing of the molten glass so the volume of molten material exposed to flow caused by the rising bubbles is maximized.

It is known that bubbling a gas through a molten glass can aid in homogenizing the glass composition. However, conventional methods of bubbling may suffer from early degradation of the melting furnace. That is, in conventional melting methods, batch materials are melted in a melting furnace or melter. Melters are often fired with both combustion burners overtop the free surface of the molten glass, while an electric current is passed through the molten glass below the free surface through electrodes in the side walls of the furnace. A gas, such as oxygen, may be bubbled into the molten glass, typically via one or more tubes that breach the refractory brick of the furnace floor, or through one or more tubes that are inserted into the glass melt through the free surface of the melt (from the “crown” of the melter). Such tubes are often constructed of a refractory metal, such as platinum or a platinum alloy (e.g. platinum-rhodium). In the first instance, the presence of bubbler tubes in the floor of the melter may increase the incidence of refractory corrosion at the bottom of the melting vessel that can lead to the presence of stones in the finished glass.

The presence of the tubes near the melter floor may also interfere with the electric currents in the melter. On the other hand, the refractory metal bubbler tubes do not interact well with the combustion atmosphere present in the melter crown, which may lead to short lifespans for the bubbler tubes, and a subsequent need for early replacement of the tubes, and significant down time for the melter.

Bubblers have also been used to bubble gas into the finer. However, the finer is often quite shallow, so the bubbles released by the bubbler have only a limited residence time in the molten glass to perform the particular task assigned to them.

### SUMMARY

In a broad aspect of the present invention, raw feed materials are heated and melted in a first refractory vessel. The resultant molten material then passes through a refractory metal tube into a second refractory vessel. The refractory metal tube is preferably comprised of a refractory metal like platinum, or a platinum alloy such as a platinum-rhodium alloy. However, other refractory metals may also be applicable, such as other metals selected from the platinum group metals, including without limitation ruthenium, rhodium, palladium, osmium, iridium and combinations thereof. As the molten material, generally referred to as molten glass, flows from the first vessel to the second vessel through the connecting tube, a gas is introduced into the molten glass passing through the tube. Preferably, the gas comprises oxygen. The gas is preferably introduced by releasing bubbles of the gas directly into the molten glass through a gas injection tube inserted into the connecting tube. The bubbles rise in the glass, and contribute to mechanical mixing (homogenization) of the molten material. If the bubbles comprise oxygen, the oxygen may additionally adjust the valence state of chemical fining agents that may be present in the molten glass. Thus, a method for introducing a gas into a glass melt is disclosed comprising providing a molten glass in a first vessel, flowing the molten glass into a second vessel through a refractory metal connecting tube that connects the first and second vessels, and introducing a gas, preferably comprising oxygen, through a gas injection tube into the molten glass flowing in the refractory metal connecting tube

In certain embodiments, a second tube may connect the second vessel to a third vessel, and the molten glass is flowed between the second and the third vessel via this second connecting tube. The third vessel may, for example, be a fining tube, wherein a temperature of the molten glass is raised to a temperature higher than the temperature of the molten glass during the melting stage in the first vessel. The oxygen containing gas may be introduced into the glass melt through the second connecting tube, prior to the entry of the molten glass into the fining tube. Thus, a method of introducing a gas into a molten glass is described comprising heating a feed material to form a molten glass in a first vessel, flowing the molten glass to a second vessel through a first refractory metal tube, flowing the molten glass from the second vessel through a second refractory metal tube to a third vessel, introducing a gas comprising oxygen into the molten glass in one or both of the first or second refractory metal tubes. That is, the gas may be introduced (bubbled) into the molten glass flowing through either the first connecting tube or the second connecting tube. In certain embodiments, the gas may be introduced into both connecting tubes.

The bubbled gas may be essentially pure oxygen. However, in some instances, oxygen may be introduced in conjunction with one or more other gases. For example, the oxygen may comprise an air mixture. In a preferred embodiment, a noble gas is also bubbled into the glass melt. Helium is a preferred noble gas as helium has a high diffusivity in the glass melt.

The invention will be understood more easily and other objects, characteristics, details and advantages thereof will become more clearly apparent in the course of the following explanatory description, which is given, without in any way implying a limitation, with reference to the attached Figures. It is intended that all such additional systems, methods, features and advantages be included within this description, be within the scope of the present invention, and be protected by the accompanying claims.

### BRIEF DESCRIPTION OF THE DRAWINGS

FIG. 1 is a cross sectional side view of a glass melting system in accordance with embodiment of the present invention.

FIG. 2 is a cross sectional side view of a portion of the glass melting process of FIG. 1, wherein the gas is bubbled into the first connecting tube connecting the first and second vessels.

FIG. 3 is a cross sectional side view of a portion of another glass melting system similar to that of FIG. 1, wherein the gas is bubbled into the second connecting tube connecting the second and third vessels.

FIG. 4 is a cross sectional side view of a portion of yet another glass melting system similar to that of FIG. 1, wherein the gas is bubbled into both the first and second connecting tubes.

FIG. 5 is a cross sectional side view of a portion of a connecting tube showing a gas injection tube disposed in the connecting tube, and wherein a longitudinal axis of the gas injection tube extending through an opening of the injection tube is substantially perpendicular to a direction of flow of the molten glass proximate the injection tube.

FIG. 6 is a cross sectional side view of a portion of a connecting tube showing a gas injection tube disposed in the connecting tube, and wherein a longitudinal axis of the gas injection tube extending through an opening of the injection tube is substantially parallel to a direction of flow of the molten glass proximate the injection tube.

FIG. 7 is a is a cross sectional side view of a portion of a connecting tube showing a gas injection tube disposed in the connecting tube, and wherein voltages may be impressed on the connecting tube and/or the injection tube to cause a current to flow through the connecting tube and/or the injection tube to heat the molten glass in the connecting tube and control a viscosity of the molten glass proximate the injection tube.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

In a typical glass making process raw feed materials are heated in a furnace (melter) to form a viscous mass, or glass melt. Furnaces are generally constructed from refractory blocks comprised of burned flint clay, sillimanite, zircon or other refractory (high temperature) material. While small furnaces may be formed from a refractory metal or metals, a refractory metal as used herein will be distinguished as such, whereas a material denoted simply as refractory will be deemed to be a ceramic or glass-ceramic. The feed materials may be introduced into the melter either by a batch process, wherein the glass forming constituents are mixed together and introduced into the melter as a discrete load, or the feed materials are mixed and introduced into the melter continuously. The feed materials may include cullet. The feed materials may be introduced into the melter through an opening or port in the furnace structure, either through the use of a push bar in the case of a batch process, or a screw or auger apparatus in the case of a continuous feed melter. The amount and type of feed material constituents makes up the glass “recipe”. Batch processes are typically used for small amounts of glass and used in furnaces having a capacity on the order of up to a few tons of glass per day, whereas a large commercial, continuous feed furnace/melter may hold in excess of 1,500 tons of glass, and deliver several hundred tons of glass per day.

The feed materials may be heated in the melter by a fuel-oxygen flame issuing from one or more burners above the feed material, by an electric current passed between electrodes typically mounted in the interior melter walls, or both. A crown structure above the walls, also made from refractory block, typically covers the melter and, in a combustion-heated furnace, provides a space for combustion of the fuel.

In some processes, the feed materials are first heated by a fuel-oxygen flame, whereupon the feed materials begin to melt and the resistivity of the feed materials decreases. An electric current is thereafter passed through the feed materials/melt mixture to heat the materials through resistive heating. During the heating, chemical reaction of the feed materials releases a variety of gases that form gaseous inclusions (bubbles), commonly referred to as blisters or seeds, within the glass melt. Seeds may also form as a result of air trapped within the interstitial spaces between the particles of feed material, and from dissolution of the refractory blocks themselves into the melt. The gases which may constitute seeds may comprise, for example, any one or a mixture of O₂, CO₂, CO, N₂ and NO. Other gases may also be formed and be entrained in the molten glass as a seed. Water is also a frequent by-product of the melting process.

During the initial stages of melting, the glass melt forms a foamy mass within the melter. This foamy mass can be a source of both seeds and solid inclusions (stones), such as unmelted batch materials, into the bulk glass. Unless seeds are removed, they may be carried through the remainder of the glass forming operations, eventually becoming frozen into the final glass product and result in visible imperfections in the product. Foam at the top of the melt may be prevented from exiting the melter by such commonly employed techniques as skimming the melt with “floaters” or by including a bridge wall within the melter. Large seeds within the melter may rise to the surface of the melt, where the gases contained within the seeds are thereby released from the molten glass. Convection currents arising from thermal gradients in the melt aid in homogenizing the melt. However, the residence time of the glass melt in the melter may be insufficient for smaller seeds to be eliminated.

To ensure maximum seed removal, glass manufacturers may employ a chemical fining process wherein a fining agent is included among the feed materials. The fining mechanism of a fining agent is to generate gas in the melt and establish a concentration difference between the gas in the melt and the gas in the seeds to drive seed growth.

Arsenic, typically in the form As₂O₅ has been used for years as a fining agent. AS₂O₅ is believed to achieve seed-free glass by reducing the arsenic from a +5 valence state to a +3 valence state at high temperature, after most melting is complete. This reduction releases oxygen into the melt that diffuses into the seeds, causing the seeds to grow and rise through and out of the melt. Arsenic has the additional advantage of assisting in the removal of any seeds that may remain in the glass during the conditioning or cooling cycle of the glass by reabsorbing excess oxygen. As such, arsenic is an outstanding fining agent, producing glass virtually free of gaseous inclusions with very little intervention.

Unfortunately, arsenic is a toxic material, and the processing of glass with arsenic results in wastes that are expensive to process and creates disposal issues relative to the display device itself after the useful life of the device is exhausted.

Antimony oxide (Sb₂O₅) may also be utilized as a substitute for arsenic, but antimony is closely related to arsenic in terms of chemical behavior and therefore possesses many of the same challenges as arsenic, such as for waste disposal.

Tin oxide (SnO₂) is another fining agent which has seen use in glass production. However, although tin oxide undergoes similar redox reactions as arsenic, the very low solubility of tin oxide (approx. 0.2 wt. %) at the forming temperature of display glasses (approximately 1200° C.) limits how much can be added to the batch and therefore the amount of oxygen available for fining. Thus, in conventional glass making processes, tin oxide has limited effectiveness as a chemical fining agent.

The concept of glass which is essentially antimony and/or arsenic-free (e.g. having less than about 0.05 wt. % of antimony or arsenic) has been previously described. For example, U.S. Pat. No. 6,128,924 discloses a group of fining agents that may be employed alone or in some combination as a substitute for arsenic for the production of glasses useful for the fabrication of LCD displays. This group includes: CeO₂, SnO₂, Fe₂O₃ and halide containing compounds. Indeed, U.S. Pat. No. 6,468,933 describes a glass forming process that employs a mixture of SnO₂ and a halide-containing compound in the form of a chloride (e.g., BaCl₂ or CaCl₂) as fining agents in a system essentially free of arsenic and antimony.

A method for enhancing a glass making process is disclosed herein. The method comprises forming a molten glass and adding a gas into the molten glass by bubbling. The gas thus introduced may benefit the melting process by improving the mixing of the molten glass, and by providing better convection flow control and enhanced energy transfer within the molten glass. Bubbling can be used to modify the chemistry of the glass by adding gas into the glass, or by using the bubbled gas to strip out other gases dissolved in the molten glass. For example, the introduced gas may serve as a center into which gases formed via the melting process may coalesce and rise to a free surface of the molten glass. In certain embodiments the usefulness of less effective fining agents, such as tin oxide for example, can be improved by effectively recharging a multivalent fining agent contained within the molten glass with oxygen if the bubbled gas contains oxygen. This is particularly true for glasses that are essentially arsenic and/or antimony free

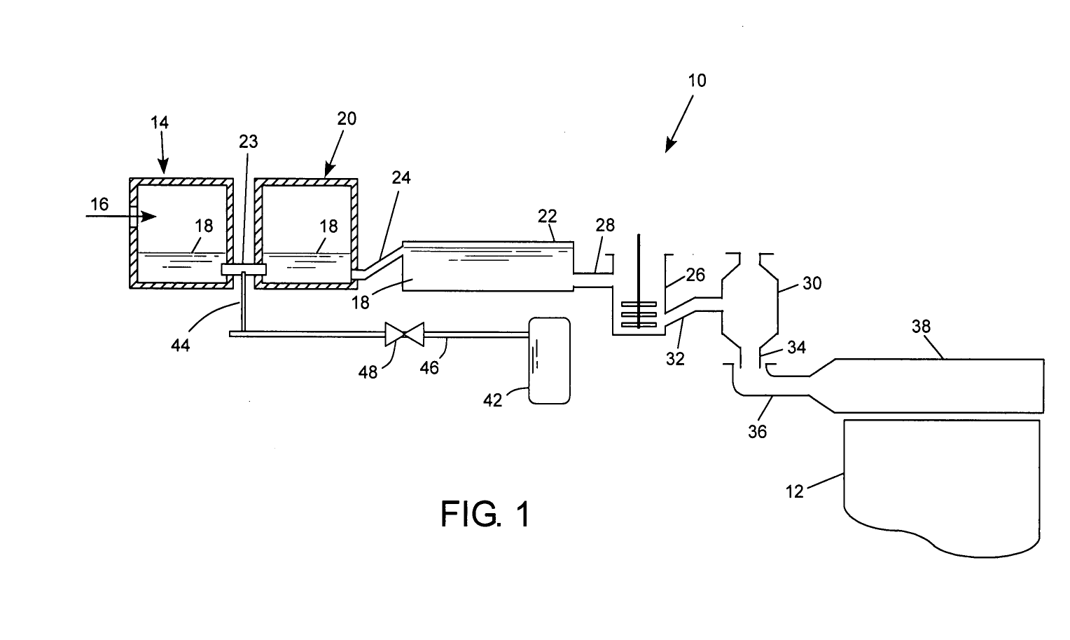

Referring to FIG. 1, there is shown a schematic view of an exemplary glass manufacturing system 10 in accordance with an embodiment of the present invention that uses a fusion process to make glass sheet 12. A fusion process is described, for example, in U.S. Pat. No. 3,338,696 (Dockerty). Glass manufacturing system 10 includes a first vessel 14 (melter 14) in which raw feed materials are introduced as shown by arrow 16 and then melted to form molten glass 18. Also included is a second vessel 20 for further conditioning of the glass melt. For example, second vessel 20 may be used as a cooling vessel to lower the temperature of the glass melt prior to increasing the temperature of the melt in a subsequent fining process. The glass manufacturing system 10 further includes components that are typically made from refractory (high temperature) metals typically including platinum or platinum-containing metals such as platinum-rhodium, platinum-iridium and combinations thereof, but which may also comprise such refractory metals as molybdenum, palladium, rhenium, tantalum, titanium, tungsten, or alloys thereof. The platinum-containing components may include fining vessel 22 (e.g. finer tube 22), a first vessel 14 to second vessel 20 connecting tube 23, a second vessel 20 to finer connecting tube 24, a mixing vessel 26 (e.g. stir chamber 26), a finer to stir chamber connecting tube 28, a delivery vessel 30 (e.g. bowl 30), a stir chamber to bowl connecting tube 32, a downcomer 34 and an inlet 36. Inlet 36 is coupled to forming vessel 38 (e.g. fusion pipe 38) which forms glass sheet 12 by overflowing the sides of the forming vessel. Typically, forming vessel 38 is made from a ceramic or glass-ceramic refractory material.

Glass raw materials are fed into melting furnace 14 in accordance with a recipe specific to the desired glass composition. The raw feed materials may be fed in a batch mode or via a continuous method, and may include, but are not limited to, oxides of Si, Al, B, Mg, Ca, Zn, Sr, or Ba. Feed materials may also be cullet from previous melting operations. The raw feed materials are heated within melting furnace 14 and melted to form glass melt 18 at a first temperature T₁. First temperature T₁ may vary depending upon the specific glass composition. For display glasses, and in particular hard glasses (i.e. glass having a high melting temperature), melting temperatures may be in excess of 1550° C.; more typically at least about 1600° C. A multivalent fining agent, such as SnO₂, may be included in the initial feed materials, or may be subsequently added to the melt. It should be noted, however, that while the present invention is particularly suited to melting operations employing alternative fining agents to arsenic and antimony, it is applicable to a wide range of melting processes, with or without the use of fining agents, and including operations employing arsenic and antimony, and should not be limited in this regard.

The feed materials may be heated by conventional glass-making methods. For example, the feed materials may be initially heated by way of combustion burners (not shown) located over the surface of the feed materials in melter 14. Once a suitable temperature has been attained through the use of combustion burners such that the resistivity of the melt is sufficiently lowered, an electric current may thereafter be passed through the body of the melt between electrodes to heat the melt from within.

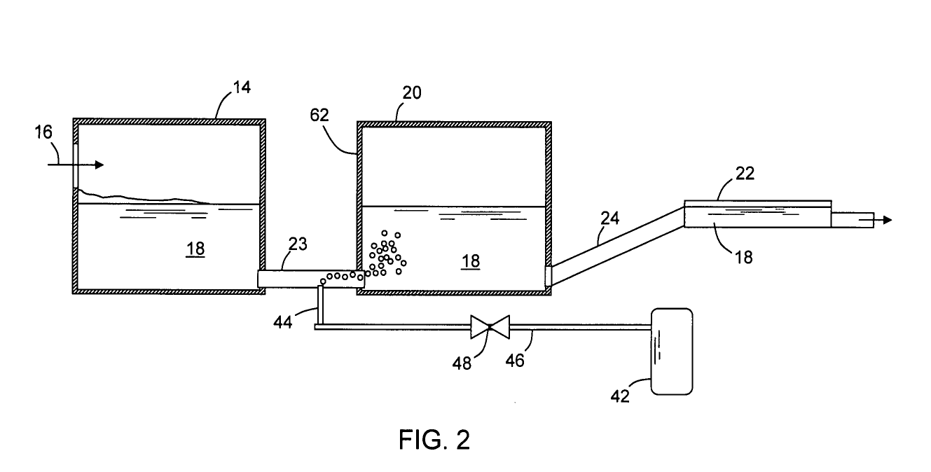

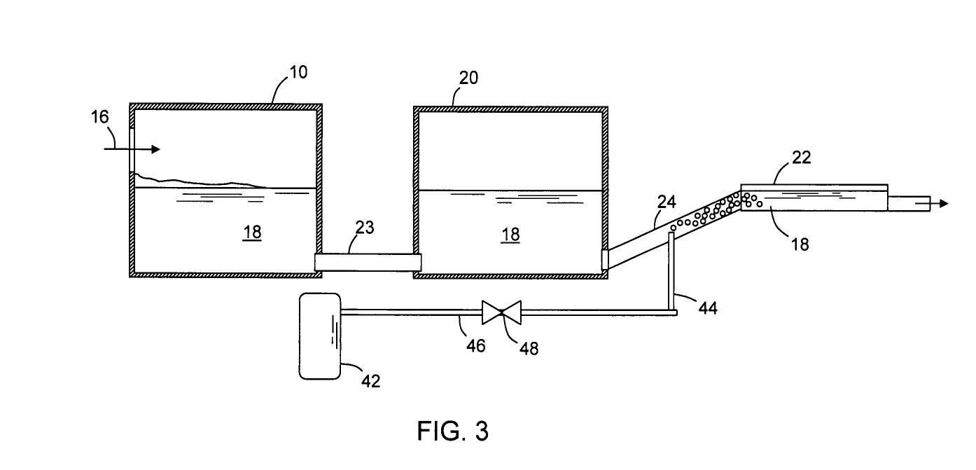

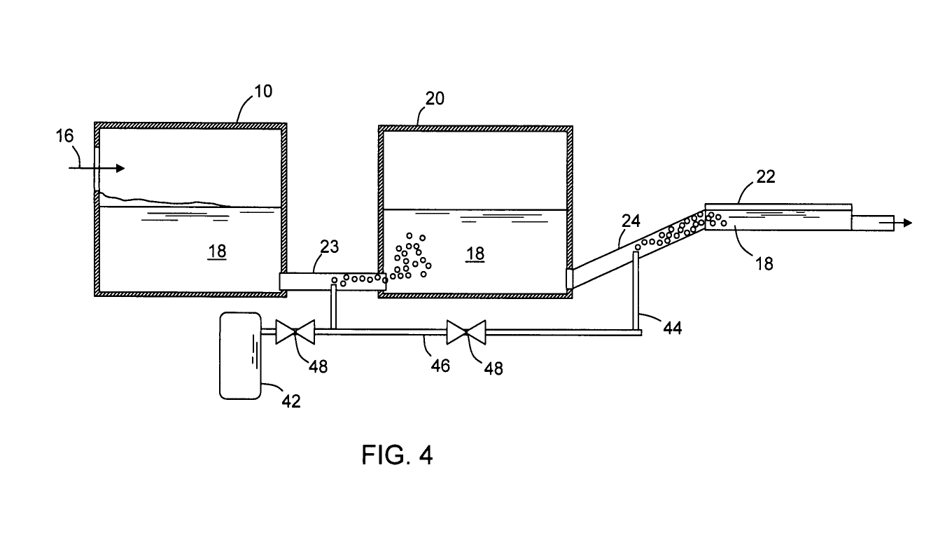

In accordance with some embodiments, once the raw feed materials have been melted at the first temperature T₁, the glass melt is transferred from first vessel 14 to second vessel 20 through first vessel to second vessel connecting tube 23. A gas is introduced into the melt via an orifice included in connecting tube 23 by bubbling the gas through the orifice. The bubbled gas preferably, but not necessarily, comprises oxygen. The glass melt may be cooled to a second temperature T₂ less than T₁ in second vessel 20 to improve the take up of oxygen by the fining agent, if included. As depicted in more detail in FIG. 2, the bubbled gas may be supplied under pressure from gas supply tank 42 to at least one injection tube 44 in connecting tube 23 through gas header 46. Valve 48 may be used to control the flow of gas to the glass melt, and may be manually or remotely/automatically controlled. The size of the gas bubbles introduced into the glass melt through injection tube 44 are preferably in a range from about 1 mm in diameter to about 40 mm in diameter, with a typical diameter being about 10 mm. In certain embodiments, the bubbled gas may be introduced via injection tubes in either one or both of connecting tube 23 and/or connecting tube 24. For example, FIG. 3 depicts bubbling of gas into connecting tube 24, whereas FIG. 4 illustrates bubbling gas into both connecting tubes 23 and 24.

Prior art methods of bubbling have generally included introducing gases into the glass melt either through gas injection tubes contained within an injection tube block in the bottom of a melting vessel (e.g. vessel 14), or through gas injection tubes entering the molten glass through the surface of the glass contained in a melter. However, there are drawbacks to either approach. For example, bubbling from the melter bottom may cause flow disruptions in the glass melt that can erode the vessel's refractory bottom, thereby creating the risk of introducing stones into the melt. On the other hand, bubbling via injection tubes (typically platinum or a platinum alloy) may be accomplished by passing the injection tubes through a free surface of the melt in the melter. If the bubbling occurs in a melting furnace employing combustion burners, the combustion-related atmosphere between the free surface of the glass melt and the furnace crown may corrode or otherwise be detrimental to the bubbling tubes,

Benefits of introducing a gas into the molten glass through one or more connecting tubes that connect vessels of the glass making system may include:
Because the entire glass melt volume will eventually pass through the connecting tubes of a multi-tank arrangement, fewer bubbles will be required to effectively contact the molten glass when the bubbles are introduced into the connecting tube or tubes.
The glass flow in the connecting tube will generally be perpendicular to the bubble growth axis, assisting with detachment of bubbles from injection tube 44. This can enable smaller diameter bubbles and/or increased gas flow per injection tube. Smaller bubbles increase the residence time in the molten glass.
A mixing benefit may be derived during the time the bubbles are in the connecting tubes. The molten glass flows in an axial direction through the connecting tube(s). However, the bubbles will have a strong upward velocity component. Because the glass flow and bubble movement are generally perpendicular to each other, effective mixing of the molten glass can be achieved.
The elimination of an injection tube block at the bottom of a melting furnace avoids having the electric current that flows in the melting furnace (e.g. furnace 14) from overheating melting furnace gas injection tube(s).

In some embodiments, the bubbled gas may be pulsed into the melt rather than introduced at a constant flow rate. That is, the flow of gas is started and stopped at a pre-determined frequency. The frequency of pulses must be sufficiently slow to allow the preceding bubble to ascend away from the outlet of the supply tube and prevent the subsequent bubbles from coalescing at the output of the supply tube.

Without wishing to be bound by theory, it is believed that for melting processes that employ fining agents, the initial concentration of multivalent fining agent valence states are in equilibrium at a given temperature and a given partial pressure of oxygen in the melt. This equilibrium is controlled by an equilibrium constant that is a function of these three parameters—melt temperature, the ratio of the valence state concentrations of the multivalent oxide fining agent (i.e. the redox ratio, equal to the concentration of reduced fining agent divided by the concentration of oxidized fining agent), and the partial pressure of oxygen. That is, for a given melt temperature and partial pressure of oxygen, there is a corresponding redox ratio. The lower the redox ratio, the more oxygen the fining agent holds. In a conventional glass making operation, the glass melt is formed at the first, melting temperature (e.g. T₁), and is then heated to a second, fining temperature (e.g. T₂) higher than the first temperature. The temperature increase from T₁ to T₂ results in reduction of the fining agent, an increase in the redox ratio, and release of oxygen into the melt. In accordance with certain embodiments of the present invention, the temperature of the glass melt may be lowered from the first temperature T₁ to a second temperature T₂ lower than the first temperature, thus creating a driving force for oxidation of the fining agent. An oxygen-containing gas may be introduced into the glass melt, such as into connecting tube 23 (and/or tube 24) via glass injection tube 44, thereby assisting in decreasing the redox ratio as the fining agent combines with the oxygen. In effect, loading the fining agent with oxygen. The glass melt may then be heated to a third temperature higher than the first temperature, typically in fining tube 22, driving the fining agent to release this oxygen. Oxygen released from the fining agent may then diffuse into the melt, and the seeds, causing the seeds to grow and rise to the surface of the melt.

In some embodiments the bubbled gas may be pure oxygen. However, care should be taken to ensure that excessive oxidation of the gas injection tube or tubes (e.g. platinum alloy) does not occur, thus it may be preferable to maintain the oxygen content below about 21% by volume. In a preferred embodiment, the bubbled gas may include oxygen mixed with one or more other gases. Preferably, the oxygen content of the bubbled gas is equal to or greater than about 1% by volume. For example, air has been found to effective. However, the oxygen is preferably mixed with any one or more of the noble (inert) gases, for example, Ar, Xe, Ne, He, Kr, N₂ or mixtures thereof under the condition that the partial pressure of oxygen within the mixed-gas bubble exceeds the partial pressure of oxygen within the melt. Advantageously, the use of a noble gas (or mixture thereof), may be used to control the partial pressure of oxygen within the pre-existing seeds. That is, by increasing or decreasing the ratio of noble gas to oxygen, the partial pressure of oxygen within the introduced bubble may be controlled. The noble gas diffuses readily within the melt and into a seed. The partial pressure of oxygen within the seeds is subsequently reduced (the existing gas concentrations within the seed are diluted), thereby increasing the amount of oxygen diffusion into the seeds: the seeds grow in volume and rise to the surface of the melt. Because the diffusivity of helium within the glass melt is especially high relative to the other inert gases, helium is a preferred noble gas. The noble gas may be introduced into the cooled molten glass as a mixture with oxygen, or the noble gas may be introduced into the cooled molten glass separately. That is, it is not necessary that both the noble gas and the oxygen be introduced as a mixture, or even contemporaneously. The introduction of noble gas into the cooled molten glass may begin before the introduction of oxygen and be completed prior to the introduction of the oxygen, or continued during the introduction of oxygen.

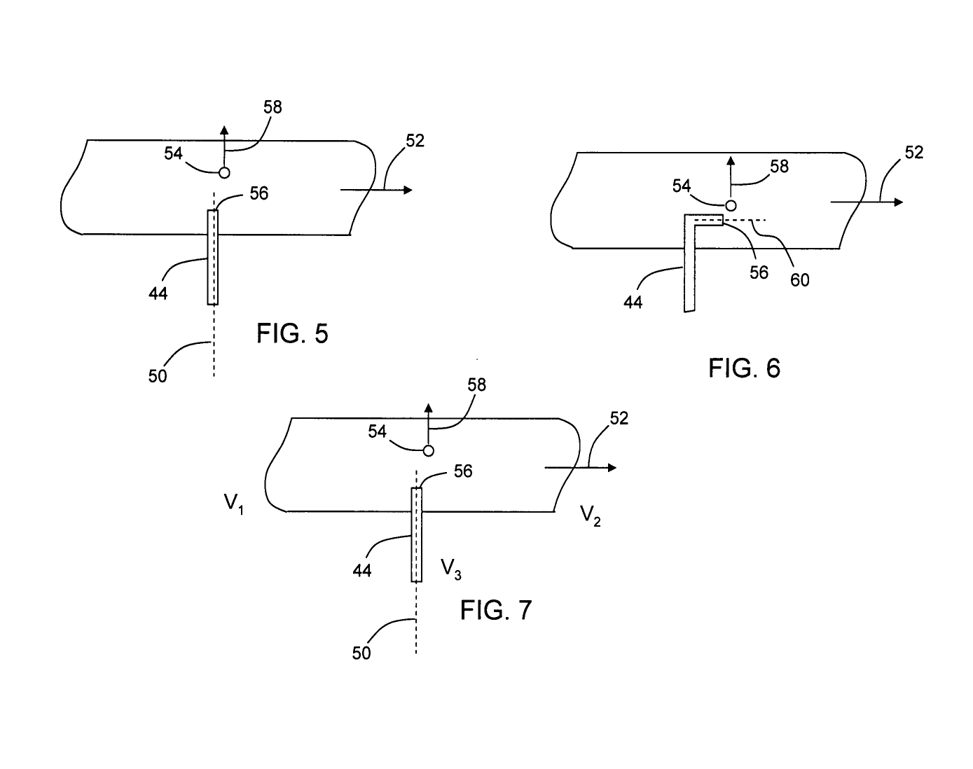

FIG. 5 illustrates a close up cross sectional side view of an embodiment of a gas injection tube 44 located in refractory metal connecting tube 23 connecting vessels 14 and 20. As depicted in FIG. 5, gas injection tube 44 comprises a longitudinal axis 50 that is generally perpendicular to the flow of molten glass through the connecting tube as depicted by arrow 52. Each bubble 54 exiting orifice 56 comprises a buoyancy vector 58 generally in a direction opposite to the pressure/density gradient in the molten glass (generally taken to be in the direction of gravity). That is, the bubbles have an upward buoyancy vector relative to the downward direction of gravity. The bubble buoyancy vector in the connecting tube is non-parallel with the direction of flow of the molten glass in the connecting tube. Simply put, the molten glass flows in one direction, and the bubbles flow in another direction that may be nearly perpendicular to the glass melt flow.

FIG. 6 is a close up cross sectional side view of another embodiment of a gas injection tube 44 wherein at least a portion of the gas injection tube comprises a longitudinal axis 60 that is generally parallel with the direction of flow of the molten glass within connecting tube 23.

The buoyancy of bubble 54 combined with the velocity of the molten glass in the connecting tube (nominally 50 ft/hr on average) assists with detachment of the bubble from the injection tube. This can allow better control of the bubble size, particularly allowing smaller bubbles than would be possible with injection tubes located within the refractory melter. Smaller bubbles have longer residence time in second vessel 20, and have high area/volume ratios that are more effective for gas exchange.

Temperature can be used to further aid in controlling the size of bubbles that are detached from the injection tube or tubes by modifying the glass viscosity. The temperature of the melt can be controlled globally by Joule heating of the connecting tube (as indicated by the voltage difference between V₁ and V₂). Additionally, local heating at the injection tube can be accomplished by imposing a voltage on the injection tube at a different voltage (V₃) or phasing, than the direct-heated connecting tube. The imposed voltages cause an electrical current to flow through the connecting tube(s) and/or the injection tube(s), thereby heating the tubes and helping to control the viscosity of the molten glass.

In some embodiments, it may be desirable to extend connecting tube 23 into second vessel 20 and away from back wall 62 to prevent the upwelling of bubble-containing molten glass entering vessel 20 from direct contact with and erosion of the back wall. In some cases, it may be desirable to extend connecting tube 23 into a central region of second vessel 20, thereby mimicking a centrally located bottom injection tube. However, proximity of the connecting tube end to back wall 62 (see FIG. 2) can beneficially create a strong upwelling of molten glass near the entrance into vessel 20 from connecting tube 23, imposing an intense mixing action on virtually all of the molten glass entering second vessel 20.

Although the invention has been described in detail for the purpose of illustration, it is understood that such detail is solely for that purpose and variations can be made therein by those skilled in the art without departing from the spirit and scope of the invention which is defined by the following claims. For example, the inventive methods disclosed herein are not limited to the manufacture of liquid crystal display glass, or necessarily to high melting temperature glasses.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. For example, the inventive method disclosed herein could be used in glass making processes other than the fusion process (e.g. float glass processes), and for products other than glass sheets for display devices. All such modifications and variations are intended to be included herein within the scope of this disclosure and the present invention and protected by the following claims.

What is claimed is:

1. A method of adding a gas into a glass melt comprising:
heating a feed material to form a molten glass in a first vessel;
flowing the molten glass to a second vessel through a first refractory metal connecting tube;
flowing the molten glass from the second vessel through a second refractory metal connecting tube to a third vessel; and
introducing a gas into the molten glass by bubbling the gas into one or both of the first and second refractory metal connecting tubes.

2. The method according to claim 1, wherein the gas comprises oxygen.

3. The method according to claim 1, wherein a temperature of the molten glass in the second vessel is less than a temperature of the molten glass in the second vessel.

4. The method according to claim 1, wherein a temperature of the molten glass in the third vessel is greater than the temperature of the molten glass in the first vessel.

5. The method according to claim 1, wherein the first and second refractory metal connecting tubes comprise platinum.

6. The method according to claim 1, wherein the bubbled gas is introduced into the molten glass through a gas injection tube comprising a longitudinal axis at an outlet of the injection tube that is substantially parallel to a direction of flow of the molten glass proximate the injection tube.

7. The method according to claim 1, wherein the bubbled gas is introduced into the molten glass through a gas injection tube comprising a longitudinal axis at an outlet of the gas injection tube that is non-parallel with a direction of flow of the molten glass proximate the injection tube.

8. The method according to claim 6, further comprising controlling a viscosity of the molten glass at a location wherein the gas is introduced.

9. The method according to claim 8, wherein the gas is introduced through a gas injection tube, and the glass viscosity is controlled by heating the injection tube with an electric current.

10. A method of making glass comprising
heating a feed material to form a molten glass in a first refractory vessel;
flowing the molten glass from the first refractory vessel into a second refractory vessel through a first refractory metal connecting tube;
adding a gas comprising oxygen into the molten glass flowing in the first refractory metal connecting tube through a gas injection tube; and
flowing the molten glass from the second refractory vessel into a third vessel through a second refractory metal connecting tube.

11. The method according to claim 10, wherein the third vessel is formed from a refractory metal.

12. The method according to claim 10, wherein the gas injection tube is heated to control a viscosity of the molten glass proximate the injection tube.

13. The method according to claim 10, wherein the added gas forms bubbles in the molten glass, and a buoyancy vector of the bubbles is substantially perpendicular to a direction of flow of the molten glass in the first refractory metal connecting tube.

14. A system for making glass articles comprising:
a melting vessel for melting feed materials to form a molten material;
a second vessel for conditioning the molten material;
a first refractory metal connecting tube connecting the melting vessel and second vessel;
a refractory metal fining vessel;
a second refractory metal connecting tube connecting the second vessel to the fining vessel;
a gas injection tube disposed in one or both of the first and second refractory metal connecting tubes for bubbling a gas into the molten material; and
a forming vessel for forming the molten material into a glass article.

15. The system according to claim. 14, wherein the first and second refractory metal connecting tubes comprise platinum.
